(19) United States
(12) Patent Application Publication
(10) Pub. No.: US 2013/0013476 A1
(43) Pub. Date: Jan. 10, 2013

(54) MOVING A FINANCIAL ACCOUNT FROM ONE ENTERPRISE TO ANOTHER

(75) Inventors: Richard Louis Knafelz, Charlotte, NC (US); David Bowman Jones, (US); John DeZervos, Morresville, NC (US); Robin Griffen Cobb, Virginia Beach, VA (US); Christopher A. Larson, New York, NY (US)

(73) Assignee: Bank of America Corporation, Charlotte, NC (US)

(21) Appl. No.: 13/177,024

(22) Filed: Jul. 6, 2011

(51) Int. Cl. G06Q 40/00

(52) U.S. Cl. 705/35

(57) ABSTRACT

According to some embodiments, a system includes an interface and one or more processors. The interface receives a request from a user to move a first account associated with a first enterprise to a second enterprise where the user has at least one account. The processor(s) determine first configuration settings associated with the first account. The processor(s) create a second account at the second enterprise, select second configuration settings based on the first configuration settings, and apply the second configuration settings to the second account.

### TECHNICAL FIELD OF THE INVENTION

The present invention relates generally to accounts and more specifically to moving a financial account from one enterprise to another.

### BACKGROUND OF THE INVENTION

Banks and other financial institutions provide financial accounts to customers. Examples of financial accounts include savings accounts, checking accounts, debit card accounts, credit card accounts, investment accounts, and so on. Customers may configure the financial accounts to facilitate financial transactions. For example, a customer may configure recurring bill payments to the customer's landlord, utility company, mortgage company, etc. to be made from the financial account.

### SUMMARY OF THE INVENTION

According to some embodiments, a system includes an interface and one or more processors. The interface receives a request from a user to move a first account associated with a first enterprise to a second enterprise where the user has at least one account. The processor(s) determine first configuration settings associated with the first account. The processor(s) create a second account at the second enterprise, select second configuration settings based on the first configuration settings, and apply the second configuration settings to the second account.

Certain embodiments of the invention may provide one or more technical advantages. A technical advantage of one embodiment includes determining configuration settings for a user's existing account associated with a first enterprise to facilitate opening a new account associated with a second enterprise. In certain embodiments, the configuration settings associated with the existing account may be applied to corresponding configuration settings in the new account. Thus, the configuration may be maintained when moving from the existing account to the new account with minimal input from the user. A technical advantage of one embodiment includes facilitating closing the account with the first enterprise in response to opening the new account with the second enterprise.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates an example of a system for moving an account from one enterprise to another enterprise;

FIG. 2 illustrates an example of a request to move an account from one enterprise to another enterprise;

FIG. 3 illustrates an example of configuration settings associated with an account; and

FIG. 4 illustrates a flowchart for moving an account from one enterprise to another enterprise.

### DETAILED DESCRIPTION OF THE INVENTION

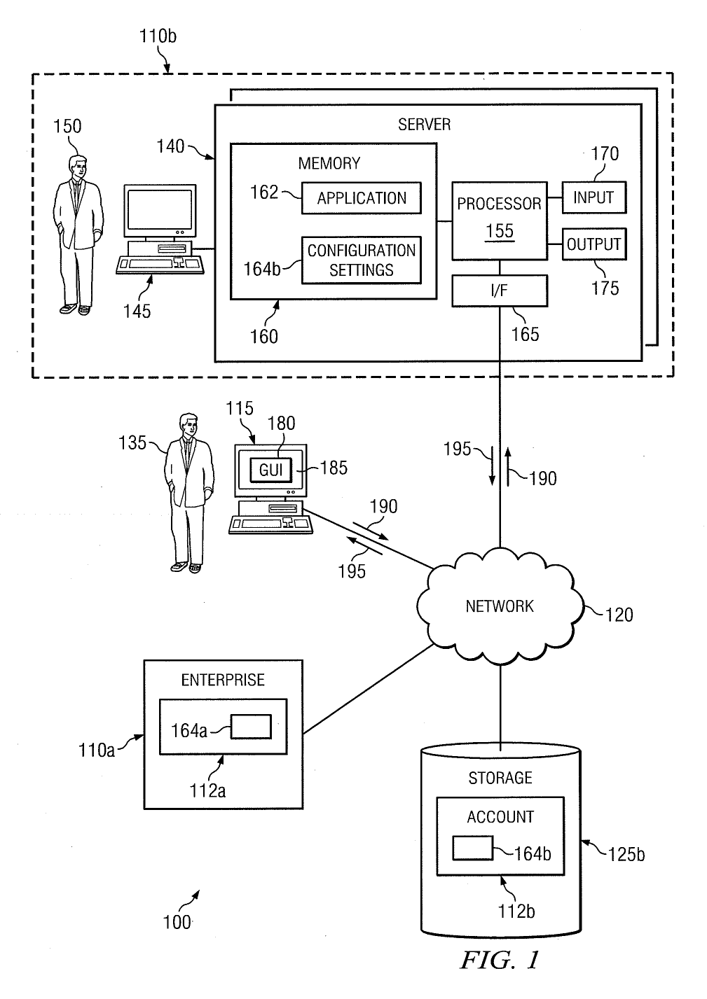

Embodiments of the present invention and its advantages are best understood by referring to FIGS. 1 through 4 of the drawings, like numerals being used for like and corresponding parts of the various drawings.

Banks and other financial institutions provide financial accounts to customers. Examples of financial accounts include savings accounts, checking accounts, debit card accounts, credit card accounts, investment accounts, and so on. Customers may configure the financial accounts to facilitate financial transactions. For example, a customer may configure recurring bill payments to the customer's landlord, utility company, mortgage company, etc. to be made from the financial account.

In certain situations, a customer may want to move an account from one enterprise to another. For example, a customer may close an account with a first financial institution and open a similar account with a second financial institution if the second financial institution provides better financial terms, better customer service, or other incentives to the customer. Or the customer may want to move an account to consolidate the number of financial institutions with which the customer maintains accounts. For example, if the customer has a savings account with the first financial institution and a checking account with the second financial institution, the customer may want to consolidate the banking relationships by closing the savings account with the first financial institution and opening a similar savings account with the second financial institution.

Typically, opening the account with the second financial institution requires the customer to spend time and effort configuring the new account. The teachings of the disclosure recognize that it would be desirable to automatically transfer configuration settings from the account being closed to the account being opened. FIGS. 1 through 4 below illustrate a system and method of moving an account from one enterprise to another enterprise.

FIG. 1 illustrates a system 100 according to certain embodiments. System 100 may include enterprises 110a, 110b, one or more clients 115, a network storage device 125, one or more servers 140, and one or more users 135. Enterprise 110, clients 115, and network storage device 125 may be communicatively coupled by a network 120. System 100 is generally operable to move an account from a first enterprise 110a to a second enterprise 110b, as described below.

In general, user 135 may provide a request 190 to move an account 112 from first enterprise 110a to second enterprise 110b. User 135 provides request 190 to server 140 associated with second enterprise 110b utilizing client 115. In some embodiments, request 190 includes an identifier, such as an account number that identifies a first account 112a, and credentials for accessing first account 112a, such as a username and password. Server 140 then determines first configuration settings 164a associated with first account 112a, for example, by logging into first account 112a with the credentials and retrieving first configuration settings 164a, such as bill pay settings, money transfer settings, and alert settings. Server 140 creates a second account 112b and uses first configuration settings to select second configuration settings 164b. Server 140 applies second configuration settings 164b to the second account 112b. In certain embodiments, server 140 generates a notification 195 to facilitate closing first account 112a. Server 140 communicates notification 195 to user 135 and/or first enterprise 110a.

Client 115 may refer to any device that enables user 135 to interact with server 140. In some embodiments, client 115 may include a computer, workstation, telephone, Internet browser, electronic notebook, Personal Digital Assistant (PDA), pager, Automatic Teller Machine (ATM) or any other suitable device (wireless, wireline, or otherwise), component, or element capable of receiving, processing, storing, and/or communicating information with other components of system 100. Client 115 may also comprise any suitable user interface such as a display 185, microphone, keyboard, or any other appropriate terminal equipment usable by a user 135. It will be understood that system 100 may comprise any number and combination of clients 115.

User 135 utilizes client 115 to interact with server 140 to move account 112 from first enterprise 110a to second enterprise 110b. In some embodiments, user 135 may be a customer of first enterprise 110a and/or second enterprise 110b. User 135 may initiate request 190 to move account 112 in order to consolidate the number of enterprises 110 with which user 135 maintains accounts, to receive better terms, better customer service, or other incentives, or for any other suitable reason.

In some embodiments, client 115 may include a graphical user interface (GUI) 180. GUI 180 is generally operable to tailor and filter data entered by and presented to user 135. GUI 180 may provide user 135 with an efficient and user-friendly presentation of request 190 and/or notification 195. GUI 180 may comprise a plurality of displays having interactive fields, pull-down lists, and buttons operated by user 135. GUI 180 may include multiple levels of abstraction including groupings and boundaries. It should be understood that the term GUI 180 may be used in the singular or in the plural to describe one or more GUIs 180 and each of the displays of a particular GUI 180.

In some embodiments, network storage device 125 may refer to any suitable device communicatively coupled to network 120 and capable of storing and facilitating retrieval of data and/or instructions. Examples of network storage device 125 include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or or any other volatile or non-volatile, non-transitory computer-readable memory devices that store one or more files, lists, tables, or other arrangements of information. Network storage device 125 may store any data and/or instructions utilized by server 140. In the illustrated embodiment, network storage device 125b stores configuration settings 164b associated with second account 112b on behalf of second enterprise 110b. In certain embodiments, system 100 may include another network storage device 125 operable to store configuration settings 164a associated with first account 112a on behalf of first enterprise 110a. FIG. 3 below illustrates an example of configuration settings 164.

In certain embodiments, network 120 may refer to any interconnecting system capable of transmitting audio, video, signals, data, messages, or any combination of the preceding. Network 120 may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

In some embodiments, enterprise 110 may refer to a financial institution such as a bank and may include one or more servers 140, an administrator workstation 145, and an administrator 150. In some embodiments, server 140 may refer to any suitable combination of hardware and/or software implemented in one or more modules to process data and provide the described functions and operations. In some embodiments, the functions and operations described herein may be performed by a pool of servers 140. In some embodiments, server 140 may include, for example, a mainframe, server, host computer, workstation, web server, file server, a personal computer such as a laptop, or any other suitable device operable to process data. In some embodiments, server 140 may execute any suitable operating system such as IBM's zSeries/Operating System (z/OS), MS-DOS, PC-DOS, MAC-OS, WINDOWS, UNIX, OpenVMS, or any other appropriate operating systems, including future operating systems.

In general, server 140 creates second account 112b associated with user 135, selects second configuration settings 164b based on first configuration settings 164a, and applies second configuration settings 164b to second account 112b. In some embodiments, servers 140 may include a processor 155, server memory 160, an interface 165, an input 170, and an output 175. Server memory 160 may refer to any suitable device capable of storing and facilitating retrieval of data and/or instructions. Examples of server memory 160 include computer memory (for example, RAM or ROM), mass storage media (for example, a hard disk), removable storage media (for example, a CD or a DVD), database and/or network storage (for example, a server), and/or or any other volatile or non-volatile, non-transitory computer-readable memory devices that store one or more files, lists, tables, or other arrangements of information. Although FIG. 1 illustrates server memory 160 as internal to server 140, it should be understood that server memory 160 may be internal or external to server 140, depending on particular implementations. Also, server memory 160 may be separate from or integral to other memory devices to achieve any suitable arrangement of memory devices for use in system 100.

Server memory 160 is generally operable to store an application 162 and configuration settings 164b. Application 162 generally refers to logic, rules, algorithms, code, tables, and/or other suitable instructions for performing the described functions and operations. In some embodiments, application 162 facilitates creating user 135's second account 112b associated with second enterprise 110b, determining first configuration settings 164a corresponding to user 135's first account 112a associated with first enterprise 110a, selecting second configuration settings 164b based on first configuration settings 164a, and applying second configuration settings 164b to second account 112b. In some embodiments, application 162 generates notification 195 to facilitate closing first account 112a.

Server memory 160 communicatively couples to processor 155. Processor 155 is generally operable to execute application 162 stored in server memory 160 to configure second account 112b according to the disclosure. Processor 155 may comprise any suitable combination of hardware and software implemented in one or more modules to execute instructions and manipulate data to perform the described functions for servers 140. In some embodiments, processor 155 may include, for example, one or more computers, one or more central processing units (CPUs), one or more microprocessors, one or more applications, and/or other logic.

In some embodiments, communication interface 165 (I/F) is communicatively coupled to processor 155 and may refer to any suitable device operable to receive input for server 140, send output from server 140, perform suitable processing of the input or output or both, communicate to other devices, or any combination of the preceding. Communication interface 165 may include appropriate hardware (e.g., modem, network interface card, etc.) and software, including protocol conversion and data processing capabilities, to communicate through network 120 or other communication system, which allows server 140 to communicate to other devices. Communication interface 165 may include any suitable software operable to access data from various devices such as clients 115 and/or network storage device 125. Communication interface 165 may also include any suitable software operable to transmit data to various devices such as clients 115 and/or network storage device 125. Communication interface 165 may include one or more ports, conversion software, or both. In general, communication interface 165 receives request 190 from clients 115 and transmits notification 195 to clients 115.

In some embodiments, input device 170 may refer to any suitable device operable to input, select, and/or manipulate various data and information. Input device 170 may include, for example, a keyboard, mouse, graphics tablet, joystick, light pen, microphone, scanner, or other suitable input device. Output device 175 may refer to any suitable device operable for displaying information to a user. Output device 175 may include, for example, a video display, a printer, a plotter, or other suitable output device.

In general, administrator 150 may interact with server 140 using an administrator workstation 145. In some embodiments, administrator workstation 145 may be communicatively coupled to server 140 and may refer to any suitable computing system, workstation, personal computer such as a laptop, or any other device operable to process data. In certain embodiments, an administrator 150 may utilize administrator workstation 145 to manage server 140 and any of the data stored in server memory 160 and/or network storage device 125.

In operation, application 162, upon execution by processor 155, facilitates moving user 135's first account 112a from first enterprise 110a to second enterprise 110b. To move first account 112a, application 162 may first receive request 190 from user 135 via client 115. In some embodiments, GUI 180 may provide locations for user 135 to enter request 190 and/or to select pre-filled options for request 190. Request 190 may include one or more identifiers indicating the account 112 that user 135 requests to move, such as the name of enterprise 110a (e.g., Bank X) and/or an account number of first account 112a. Request 190 may include credentials to access first account 112a, such as a username and password.

Once application 162 receives request 190, application 162 creates second account 112b. Application 162 determines first configuration settings 164a corresponding to first account 112a. For example, application 162 facilitates logging into first account 112a according to the identifier and credentials of request 190 and retrieving first configuration settings 164a. Application 162 selects second configuration settings 164b based on the first configuration settings 164a and applies second configuration settings 164b to second account 112b.

In some embodiments, application 162 generates notification 195 to facilitate closing first account 112a and communicates notification 195 via interface 165 to client 115. Notification 195 may comprise a document for user 135 to authorize (e.g., sign) and provide to first enterprise 110a in order to close first account 112a. In certain embodiments, application 162 communicates notification 195 to first enterprise 110a. Notification 195 may inform first enterprise 110a that user 135 initiated steps to close first account 112a. In certain embodiments, first enterprise 110a may wait to close first account 112a until user 135 authorizes (e.g., signs) the document included in notification 195 and provides the authorized document to first enterprise 110a.

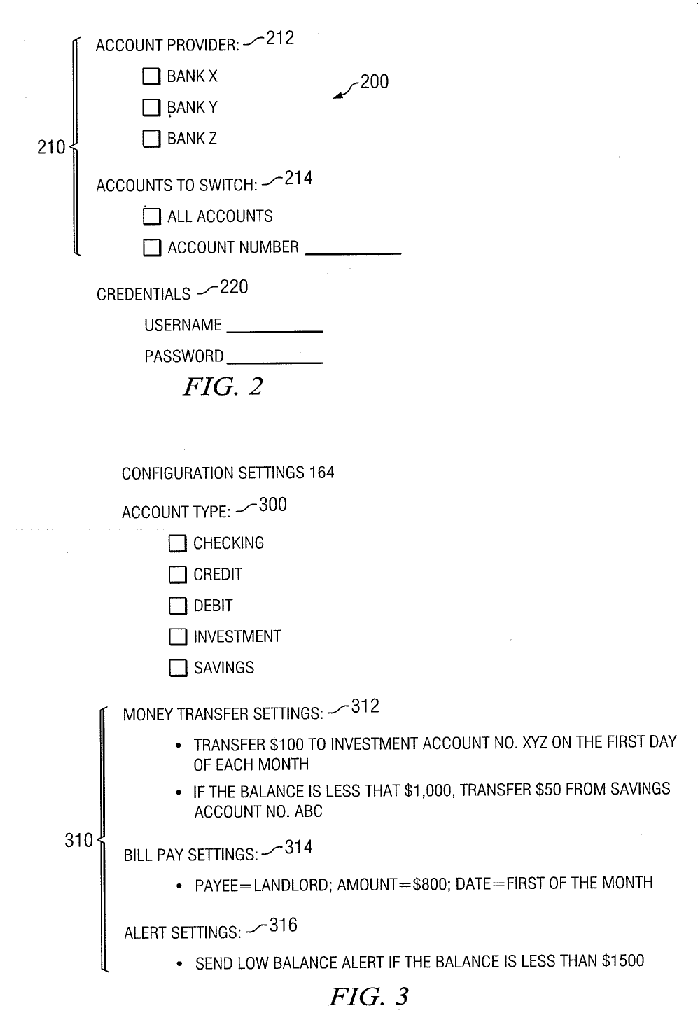

FIG. 2 illustrates an example of a request prompt 200 operable to prompt user 135 to provide information that client 115 uses to generate request 190 requesting to move first account 112a from first enterprise 110a to second enterprise 110b. In certain embodiments, server 140 communicates request prompt 200 to client 115, client 115 communicates request prompt 200 to user 135, user 135 provides information indicated by request prompt 200, and client 115 generates request 190 based on the information provided by user 135.

Request prompt 200 may include one or more identifiers 210 and credentials 220. Identifiers 210 identify one or more accounts 112 that user 135 requests to move from first enterprise 110a to second enterprise 110b. Identifiers 210 may include an account provider identifier 212 and selected accounts identifier 214. In certain embodiments, account provider identifier 212 includes a list of potential enterprises 110, such as enterprises 110 from which second enterprise 110b may retrieve configuration settings. User 135 selects the name of first enterprise 110a from the list of potential enterprises 110.

Selected accounts identifier 214 prompts user 135 to select one or more accounts 112 to move from first enterprise 110a to second enterprise 110b. In certain embodiments, request prompt 200 may provide user 135 with the option to move all of the accounts 112 that first enterprise 110a associates with user 135. For example, if user 135 has a checking account and a savings account with first enterprise 110a, user 135 may choose to move both accounts 112 to second enterprise 110b. Alternatively, user 135 may choose to move one or more specific accounts 112 to second enterprise 110b. Accordingly, request prompt 200 may prompt user 135 to identify the account(s) 112 to be moved, for example, according to an account number.

Credentials 220 may include information that first enterprise 110a verifies prior to allowing access to the account(s) 112 that first enterprise 110a associates with user 135. Examples of credentials 220 include a username and/or a password. Second enterprise 110b may use credentials 220 provided in request 190 to access the account(s) 112 in order to retrieve first configuration settings 164a that first enterprise 110a associates with user 135's account(s).

FIG. 3 illustrates an example of configuration settings 164 associated with account 112. Examples of configuration settings 164 include account type 300, account rules 310, and other configurable information. In certain embodiments, account type 300 may correspond to a financial account, such as a checking account, a credit account, a debit account, an investment account, or a savings account. Account rules 310 may include rules configured by user 135 to manage account 112 and/or facilitate transactions. Examples include money transfer settings 312, bill pay settings 314, alert settings 316, and so on.

Money transfer settings 312 may indicate rules for transferring money into or out of account 112. As an example, user 135 may configure account 112 to periodically transfer money from account 112 to an investment account associated with user 135. As another example, user 135 may configure account 112 to transfer money from a savings account to account 112 if the balance of account 112 is less than a threshold amount selected by user 135. Bill pay settings 314 may indicate rules for paying bills to third parties, such as user 135's landlord, utility company, and so on. In certain embodiments, user 135 may configure the bill pay settings 314 with a payee, an amount to be paid, and a time period for making the payment. Alert settings 316 may indicate rules for alerting user 135 regarding the status of the account, such as when the balance is low or when a large transaction has been requested.

In certain embodiments, first configuration settings 164a associated with first account 112a (e.g., the account being closed) may be used to select second configuration settings 164b associated with second account 112b (e.g., the account being opened). First configuration settings 164a may be copied on a like-for-like basis, modified, deleted, or a combination of the preceding in order to yield second configuration settings 164b. In certain embodiments, first configuration settings 164a may be automatically copied to corresponding second configuration settings 164b. Alternatively, in certain embodiments, user 135 may select whether to copy some or all of the first configuration settings 164a to corresponding second configuration settings 164b, or whether to modify or delete certain first configuration settings 164a.

As an example, first account 112a may correspond to a checking account configured to alert user 135 if the account balance is less than a minimum dollar amount and to pay rent to user 135's landlord on a monthly basis. An example of copying a first configuration setting 164a may be to configure second account 112b as a checking account. An example of modifying a first configuration setting 164a may be to increase or decrease the minimum dollar amount that triggers the account balance alert. For example, if first enterprise 110a offers terms such that first account 112a becomes interest-bearing when the account balance is greater than $X, and second enterprise 110b offers terms such that second account 112b becomes interest-bearing when the account balance is greater than $Y, user 135 may opt to change the account balance alert's minimum dollar amount from $X to $Y. An example of deleting a first configuration setting 164a may be to delete the monthly rent payment, for example, if user 135 chooses not to transact the rent payment through second account 112b. In certain embodiments, user 135 may have the option of moving the rent payment or other configuration settings 164a to a different account that second enterprise 110b associates with user 135 (e.g., an account other than the account being opened).

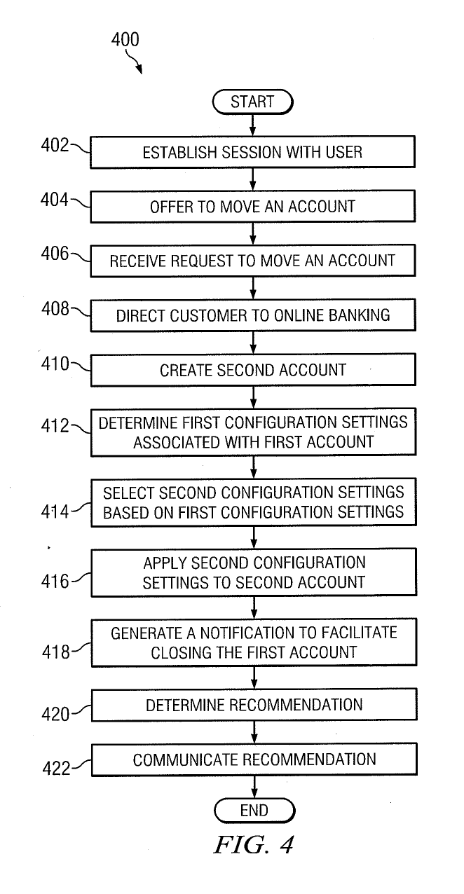

FIG. 4 illustrates a flowchart 400 for moving an account 112 from one enterprise 110a to another enterprise 110b. The method begins at step 402 by establishing a session between client 115 associated with user 135 and server 140 associated with second enterprise 110b. In certain embodiments, user 135 may be an existing customer of second enterprise 110b and may have at least one account 112 associated with second enterprise 110b. As an example, a session may be established between client 115 and server 140 if user 135 initiates logging into the at least one account 112 (e.g., to conduct banking through user 135's existing account(s)) and server 140 successfully authenticates client 115. Server 140 may authenticate client 115 according to any suitable criteria, such as a username and password that second enterprise 110b associates with user 135.

At step 404, server 140 communicates an offer to client 115, and client 115 communicates the offer to user 135. The offer asks if user 135 would like to move an account 112 from another enterprise, such as first enterprise 110a, to second enterprise 110b. As an example, user 135 may want to close first account 112a associated with first enterprise 110a and open a second, similar account 112b with second enterprise 110b if second enterprise 110b provides better financial terms, better customer service, or other incentives to user 135. Or user 135 may want to move first account 112a to second enterprise 110b where user 135 has at least one account 112 in order to consolidate the number of enterprises 110 with which user 135 maintains accounts 112.

Server 140 receives request 190 to move an account, such as first account 112a, at step 406. Request 190 may include an identifier 210 identifying first account 112a and credentials 220 for accessing first account 112a. At step 408, server 140 may direct user 135 to online banking features for existing accounts 112 that second enterprise 110b associates with user 135. Accordingly, user 135 may conduct online banking as normal while server 140 creates and configures second account 112b in the background.

At step 410, server 140 creates second account 112b. For example, server 140 opens a new account associated with user 135. At step 412, server 140 determines first configuration settings 164a associated with first account 112a. In certain embodiments, server 140 logs into systems associated with first enterprise 110a according to credentials 220 provided by user 135 via request 190. Server 140 then retrieves first configuration settings 164a from first enterprise 110a. First configuration settings 164a may include account type 300 and/or account rules 310.

Server 140 selects second configuration settings 164b at step 414. Second configuration settings 164b may be selected based on first configuration settings 164a determined in step 412. First configuration settings 164a may be copied on a like-for-like basis, modified, deleted, or a combination of the preceding in order to yield second configuration settings 164b. In certain embodiments, server 140 may store first configuration settings 164a in network storage device 125b associated with second enterprise 110b. Server 140 may refer to the stored first configuration settings 164a for any suitable purpose, such as verifying second configuration settings 164b or restoring a default configuration for second account 112b.

Server 140 applies second configuration settings 164b to second account 112b at step 416. Applying second configuration settings 164b configures second account 112b and facilitates implementing the tasks indicated by rules 310. That is, when a condition indicated by a particular rule 310 has been met, server 140 implements the task corresponding to the rule. For example, server 140 may pay rent to user 135's landlord on the first day of each month, transfer funds to an investment account associated with user 135 on the first day of each month, or alert user 135 if the account balance falls below a threshold.

At step 418, server 140 generates notification 195 to facilitate closing first account 112a and communicates notification 195 to user 135 via client 115. Notification 195 may comprise a document for user 135 to authorize (e.g., sign) and provide to first enterprise 110a in order to close first account 112a. In certain embodiments, server 140 communicates notification 195 to first enterprise 110a. Notification 195 may inform first enterprise 110a that user 135 initiated steps to close first account 112a. In certain embodiments, first enterprise 110a may wait to close first account 112a until user 135 authorizes (e.g., signs) the document included in notification 195 and provides the authorized document to first enterprise 110a.

Server 140 determines whether to make a recommendation to change one or more second configuration settings 164b at step 420. In certain embodiments, server 140 may compare the account balance to account type 300 to determine whether to make a recommendation. As an example, if the account balance of second account 112b is relatively high and the account type 300 corresponds to a savings account, server 140 may recommend to change account type 300 to an investment account or to transfer a portion of the funds to an investment account. In certain embodiments, server 140 may compare configuration settings 164b to terms offered by second enterprise 110b to determine whether to make a recommendation. As an example, if account type 300 corresponds to a checking account, server 140 may recommend setting a low balance alert at $Y if second enterprise 110b allows second account 112b to become interest-bearing when the balance is greater than $Y. In certain embodiments, the recommendation may facilitate setting up a meeting with an employee of second enterprise 110b in order to determine updated second configuration settings 164b customized to user 135's financial objectives. At step 422, server 140 communicates the recommendation to client 115, and client 115 communicates the recommendation to user 135. The method then ends.

Modifications, additions, or omissions may be made to the systems described herein without departing from the scope of the invention. The components may be integrated or separated. Moreover, the operations may be performed by more, fewer, or other components. Additionally, the operations may be performed using any suitable logic comprising software, hardware, and/or other logic. As used in this document, “each” refers to each member of a set or each member of a subset of a set.

Modifications, additions, or omissions may be made to the methods described herein without departing from the scope of the invention. For example, the steps may be combined, modified, or deleted where appropriate, and additional steps may be added. Additionally, the steps may be performed in any suitable order without departing from the scope of the present disclosure.

Although the present invention has been described in detail, it should be understood that various changes, substitutions, and alterations can be made hereto without departing from the scope of the invention as defined by the appended claims.

1. A system, comprising:
an interface operable to:
receive a request from a user to move a first account associated with a first enterprise to a second enterprise, wherein the user has at least one account associated with the second enterprise; and
one or more processors operable to:
create a second account at the second enterprise, the second account associated with the user;
determine first configuration settings associated with the first account;
select second configuration settings associated with the second account based on the first configuration settings;
apply the second configuration settings to the second account;
generate an account closure authorization document; and
transmit the account closure authorization document to at least one of the user and the first enterprise.

2. The system of claim 1, the one or more processors further operable to create the second account at the second enterprise in response to the request to move the first account associated with the first enterprise to the second enterprise.

3. The system of claim 1, wherein the first account comprises a savings account, a checking account, a debit card account, a credit card account, or an investment account.

4. The system of claim 1, wherein the first configuration settings include bill pay settings, money transfer settings, or alert settings.

5. The system of claim 1, wherein the account closure authorization document comprises a form for the user to sign and present to the first enterprise to close the first account.

6. The system of claim 1, wherein the request comprises an identifier identifying the first account and credentials for accessing the first configuration settings.

7. The system of claim 1, the one or more processors further operable to determine a recommendation for the second account according to the second configuration settings, and the interface further operable to communicate the recommendation.

8. A non-transitory computer readable storage medium comprising logic, the logic, when executed by a processor, operable to:
receive a request from a user to move a first account associated with a first enterprise to a second enterprise, wherein the user has at least one account associated with the second enterprise;
create a second account at the second enterprise, the second account associated with the user;
determine first configuration settings associated with the first account;
receive a modification request from a user to modify the first configuration settings;
select second configuration settings associated with the second account based on the first configuration settings and the modification request; and
apply the second configuration settings to the second account.

9. The medium of claim 8, the logic further operable to create the second account at the second enterprise in response to the request to move the first account associated with the first enterprise to the second enterprise.

10. The medium of claim 8, wherein the first account comprises a savings account, a checking account, a debit card account, a credit card account, or an investment account.

11. The medium of claim 8, wherein the first configuration settings include bill pay settings, money transfer settings, or alert settings.

12. The medium of claim 8, the logic further operable to generate a notification to facilitate closing the first account.

13. The medium of claim 8, wherein the request comprises an identifier identifying the first account and credentials for accessing the first configuration settings.

14. The medium of claim 8, the logic further operable to determine a recommendation for the second account according to the second configuration settings.

15. A method, comprising:
displaying, on a computer, a compatibility list, the compatibility list comprising at least one first enterprise from which a user may transfer a first account to a second enterprise;
receiving a request from the user to move the first account associated with the first enterprise selected from the compatibility list to the second enterprise, wherein the user has at least one account associated with the second enterprise;
creating a second account at the second enterprise, the second account associated with the user;
determining first configuration settings associated with the first account;
selecting second configuration settings associated with the second account based on the first configuration settings; and
applying the second configuration settings to the second account.

16. The method of claim 15, further comprising creating the second account at the second enterprise in response to the request to move the first account associated with the first enterprise to the second enterprise.

17. The method of claim 15, wherein the first configuration settings include bill pay settings, money transfer settings, or alert settings.

18. The method of claim 15, further comprising generating a notification to facilitate closing the first account and communicating the notification.

19. The method of claim 15, wherein the request comprises an identifier identifying the first account and credentials for accessing the first configuration settings.

20. The method of claim 15, further comprising:
determining a recommendation for the second account according to the second configuration settings; and
communicating the recommendation.
